(19) United States
(12) Patent Application Publication
(10) Pub. No.: US 2024/0062072 A1
(43) Pub. Date: Feb. 22, 2024

(54) FEDERATED LEARNING SYSTEM AND FEDERATED LEARNING METHOD

(71) Applicants: NATIONAL INSTITUTE OF INFORMATION AND COMMUNICATIONS TECHNOLOGY, Koganei-shi, Tokyo (JP); NATIONAL UNIVERSITY CORPORATION KOBE UNIVERSITY, Kobe-shi, Hyogo (JP)

(72) Inventors: Lihua WANG, Tokyo (JP); Fuki YAMAMOTO, Kobe-shi (JP); Seiichi OZAWA, Kobe-shi (JP)

(73) Assignees: NATIONAL INSTITUTE OF INFORMATION AND COMMUNICATIONS TECHNOLOGY, Koganei-shi, Tokyo (JP); NATIONAL UNIVERSITY CORPORATION KOBE UNIVERSITY, Kobe-shi, Hyogo (JP)

(21) Appl. No.: 18/269,747

(22) PCT Filed: Dec. 24, 2021
(86) PCT No.: PCT/JP2021/048383

§ 371 Date: Jun. 26, 2023

(30) Foreign Application Priority Data
Dec. 25, 2020 (JP) 2020-217245

(51) Int. Cl. G06N 3/098

(52) U.S. Cl. CPC G06N 3/098

(57) ABSTRACT

A federated learning system in which a plurality of local servers repeatedly learn cooperatively through communications between the plurality of local servers and a central server via a network. The local server includes a decryption unit, a mean gradient calculation unit, a model updating unit, a validation error calculation unit, an encryption unit, and a local transmission unit that transmits at least one of a current local mean gradient and a current local validation error. The central server includes a central reception unit, a model selection unit, a weight determination unit, and a central transmission unit. The central reception unit receives encrypted current local models and at least one of current local training data counts, the current local mean gradients, and the current local validation errors from the plurality of respective local servers.

### TECHNICAL FIELD

The present invention relates to a federated learning system and a federated learning method.

### BACKGROUND ART

Recently, a demand for cross-sectional data analysis of data held by a plurality of servers has been increasing. For example, when a system for detecting an illegal money transfer is established in a bank, data in only one server is not enough, and it is difficult to establish a model with sufficient accuracy. In view of this, for example, a learning system, as disclosed in Patent Document 1, that intends to improve learning efficiency by optimizing reproducibility in deep learning between a plurality of user terminals via a server has been attracting attention.
Patent Document 1: JP-A-2019-121256

### DISCLOSURE OF THE INVENTION

### Problems to be Solved by the Invention

However, in the technique disclosed in Patent Document 1, since the deep learning is used, an indicator for examining an output result is not indicated, and it is difficult to explain the validity of the output result based on the process of output. Therefore, there is a problem that it is difficult to determine whether the technique disclosed in Patent Document 1 is applicable or not.

Thus, the present invention has been made in consideration of the above-described problem, and it is an object of the present invention to provide a federated learning system and a federated learning method capable of explaining the validity of an output result based on the process of output.

### Solutions to the Problems

A federated learning system according to a first invention is a federated learning system in which a plurality of local servers repeatedly learn cooperatively through communication between the plurality of local servers and a central server via a network. The local server includes: a local reception unit that receives an encrypted previous global model and a previous weight from the central server, a decryption unit that decrypts the received encrypted previous global model, and generates a previous global model; a mean gradient calculation unit that calculates a current local mean gradient from the previous global model, past global models before the previous time, and current local data including current local training data and a current local training data count stored in the local server; a model updating unit that generates a current local model from the previous global model, the past global models, and the current local data; a validation error calculation unit that calculates a current local validation error from the current local model and the current local data; an encryption unit that encrypts the current local model, and generates an encrypted current local model; and a local transmission unit that transmits the encrypted current local model and at least one of the current local training data count, the current local mean gradient, and the current local validation error. The global model and the local model are each a model as a decision tree or a decision tree group including a shape of a tree and a branch condition. The central server includes: a central reception unit that receives the encrypted current local models and at least one of the current local training data counts, the current local mean gradients, and the current local validation errors from the plurality of respective local servers; a model selection unit that selects at least one of the encrypted current local models received from the plurality of respective local servers by a predetermined method, and sets the selected encrypted current local model as an encrypted current global model; a weight determination unit that determines a current weight of the encrypted current global model by a predetermined method; and a central transmission unit that transmits the encrypted current global model and the current weight to each of the plurality of local servers.

In a federated learning system according to a second invention, which is in the first invention, the current local data is calculated using a part of or all of local data up to the previous time, and the learning is continuous learning.

In a federated learning system according to a third invention, which is in the first invention, the model selection unit aligns the encrypted current local models received from the plurality of local servers by a predetermined method using at least one of the current local training data counts, the current local mean gradients, and the current local validation errors received from the plurality of respective local servers, and the model selection unit selects at least one as the encrypted current global model by a predetermined method.

In a federated learning system according to a fourth invention, which is in the first invention, the weight determination unit sets the current weights of the selected encrypted current global models to be the same.

In a federated learning system according to a fifth invention, which is in the first invention, the weight determination unit determines the current weight of the encrypted current global model using at least one of the current local training data counts, the current local mean gradients, and the current local validation errors received from the plurality of respective local servers.

A federated learning method according to a sixth invention is a federated learning method by a federated learning system in which a plurality of local servers repeatedly learn cooperatively through communication between the plurality of local servers and a central server via a network. The federated learning method includes: in the local server, a first step of receiving an encrypted previous global model and a previous weight from the central server; a second step of decrypting the received encrypted previous global model, and generating a previous global model; a third step of calculating a current local mean gradient from the previous global model, past global models before the previous time, and current local data including current local training data and a current local training data count stored in the local server; a fourth step of generating a current local model from the previous global model, the past global models, and the current local data; a fifth step of calculating a current local validation error from the current local model and the current local data; a sixth step of encrypting the current local model, and generating an encrypted current local model; and a seventh step of transmitting the encrypted current local model and at least one of the current local training data count, the current local mean gradient, and the current local validation error. The global model and the local model are each a model as a decision tree or a decision tree group including a shape of a tree and a branch condition. The federated learning method includes: in the central server, an eighth step of receiving the encrypted current local models and at least one of the current local training data counts, the current local mean gradients, and the current local validation errors from the plurality of respective local servers; a ninth step of selecting at least one of the encrypted current local models received from the plurality of respective local servers by a predetermined method, and setting the selected encrypted current local model as an encrypted current global model; a tenth step of determining a current weight of the encrypted current global model by a predetermined method; and an eleventh step of transmitting the encrypted current global model and the current weight to each of the plurality of local servers.

A federated learning system according to a seventh invention is a federated learning system in which a global model is communicated between a plurality of local servers and repeatedly learned cooperatively. The global model is a decision tree or a decision tree group including a shape of a tree indicating a relation between local training data and a weight of the relation. The federated learning system includes: a model generation unit that generates current local models for the respective two or more local servers based on a global model generated by past learning and current local training data used for current learning; an evaluation unit that evaluates the current local models generated for the respective two or more local servers by the model generation unit via at least one of the local servers; and a model updating unit that selects at least one of the current local models generated for the respective two or more local servers by the model generation unit based on the evaluation by the evaluation unit, and updates the global model based on the selected current local model.

A federated learning system according to an eighth invention, which is in the seventh invention, includes: a transmission unit that transmits the current local models generated by the model generation unit for the respective two or more local servers; a sorting unit that sorts the two or more current local models transmitted for the respective two or more local servers by the transmission unit; and a central transmission unit that transmits the two or more current local models sorted by the sorting unit to at least one of the local servers.

In a federated learning system according to a ninth invention, which is in the seventh invention or the eighth invention, the transmission unit encrypts the current local models generated for the respective two or more local servers by the model generation unit, and transmits the encrypted current local models.

A federated learning system according to a tenth invention is a federated learning system in which a global model is communicated between a plurality of local servers and repeatedly learned cooperatively. The global model is a decision tree or a decision tree group including a shape of a tree indicating a relation between local training data and a weight of the relation. The federated learning system includes: a model generation unit that generates a current local model via at least one of the local servers based on a global model generated by past learning and current local training data used for current learning; a gradient calculation unit that calculates gradient values for the respective two or more local servers based on the current local model generated by the model generation unit, the global model, and the current local training data, the gradient value being based on a function indicating an error between a predicted value and a measured value of an output result of the current local model; a calculation unit that calculates the weight based on the gradient values calculated for the respective two or more local servers by the gradient calculation unit; and a global model updating unit that updates the global model based on the current local model generated by the model generation unit and the weight calculated by the calculation unit.

In a federated learning system according to an eleventh invention, which is in the tenth invention, the gradient calculation unit encrypts the gradient values calculated for the respective two or more local servers, calculates cumulative gradient values by cumulating the respective encrypted gradient values, and transmits the calculated cumulative gradient values to the respective two or more local servers, and the calculation unit calculates the weights for the respective two or more local servers based on the cumulative gradient values transmitted by the gradient calculation unit.

In a federated learning system according to a twelfth invention, which is in the tenth invention, the calculation unit transmits the calculated weights to the respective two or more local servers, and the global model updating unit updates the global models for the respective two or more local servers.

In a federated learning system according to a thirteenth invention, which is in any of the tenth invention to the twelfth invention, the model generation unit encrypts the generated current local model.

A federated learning system according to a fourteenth invention, which is in any of the tenth invention to the thirteenth invention, further includes a selection unit that selects a local server for generating the current local model from the two or more local servers. The model generation unit generates the current local model by the local server selected by the selection unit.

In a federated learning system according to a fifteenth invention, which is in any of the tenth invention to the fourteenth invention, the model generation unit generates a dummy model for calculating a random value as the current local model or the gradient value, and the gradient calculation unit calculates the random value as the gradient value based on the dummy model generated by the model generation unit.

A federated learning method according to a sixteenth invention is a federated learning method in which a global model is communicated between a plurality of local servers and repeatedly learned cooperatively. The global model is a decision tree or a decision tree group including a shape of a tree indicating a relation between local training data and a weight of the relation. The federated learning method includes: a model generation step of generating current local models for the respective two or more local servers based on a global model generated by past learning and current local training data used for current learning; an evaluation step of evaluating the current local models generated for the respective two or more local servers by the model generation step via at least one of the local servers; and a model updating step of selecting at least one of the current local models generated for the respective two or more local servers by the model generation step based on the evaluation by the evaluation step, and updates the global model based on the selected current local model.

A federated learning method according to a seventeenth invention is a federated learning method in which a global model is communicated between a plurality of local servers and repeatedly learned cooperatively. The global model is a decision tree or a decision tree group including a shape of a tree indicating a relation between local training data and a weight of the relation. The federated learning method includes: a model generation step of generating a current local model via at least one of the local servers based on a global model generated by past learning and current local training data used for current learning; a gradient calculation step of calculating gradient values for the respective two or more local servers based on the current local model generated by the model generation step, the global model, and the current local training data, the gradient value being based on a function indicating an error between a predicted value and a measured value of an output result of the current local model; a calculation step of calculating the weight based on the gradient values calculated for the respective two or more local servers by the gradient calculation step; and a global model updating step of updating the global model based on the current local model generated by the model generation step and the weight calculated by the calculation step.

### Effects of the Invention

According to the first invention to the sixth invention, at least one of the encrypted current local models received from the plurality of respective local servers is selected by a predetermined method, and set as the encrypted current global model. Accordingly, a degree of importance of an explanatory variable calculated in the computation in a central server 2 can be obtained, and a selection index such as a mean gradient is not encrypted. Therefore, the validity of the output result is easily explained based on the process of output.

Especially, according to the second invention, the current local data is calculated using a part of or all of the local data up to the previous time, and the learning is continuous learning. Accordingly, the output result is provided with higher accuracy.

Especially, according to the third invention, the model selection unit aligns the encrypted current local models received from the plurality of local servers by a predetermined method using at least one of the current local training data counts, the current local mean gradients, and the current local validation errors received from the plurality of respective local servers, and the model selection unit selects at least one as the encrypted current global model by a predetermined method. Accordingly, since the encrypted current local model can be selected using any of the current local training data count, the current local mean gradient, and the current local validation error, the output result is provided with higher accuracy.

Especially, according to the fourth invention, the weight determination unit sets the current weights of the selected encrypted current global models to be the same. Therefore, the current local model can be randomly selected. Accordingly, since the calculation amount in the selection can be reduced, speed-up can be expected.

Especially, according to the fifth invention, the weight determination unit determines the current weight of the encrypted current global model using at least one of the current local training data counts, the current local mean gradients, and the current local validation errors received from the plurality of respective local servers. Accordingly, since the weight can be determined using at least one of the current local training data count, the current local mean gradient, and the current local validation error, the output result is provided with higher accuracy.

According to the seventh invention to the ninth invention, at least one of the current local models is selected based on the evaluation, and the global model is updated based on the selected current local model. This allows reflecting the current global model in which the contents of the local training data stored in two local servers 1 have been reflected in the global model, in the global model. Accordingly, the federated learning system capable of explaining the validity of the output result with higher accuracy based on the process of output can be achieved.

Especially, according to the eighth invention, the plurality of current local models transmitted for the plurality of respective local servers are sorted. This makes it impossible to identify which local server generates which local model from the transmission order of the current local models from the plurality of local servers, and therefore, the confidentiality can be enhanced.

Especially, according to the ninth invention, the current local models generated for the plurality of respective local servers are encrypted, and the encrypted current local models are transmitted. This allows enhancing the confidentiality.

According to the tenth invention to the fifteenth invention, the weight is calculated based on the gradient values calculated for the plurality of respective local servers. This allows reflecting the current global model in which the contents of the local training data stored in the two or more local servers 1 have been reflected in the global model, in the global model. Accordingly, the federated learning system capable of explaining the validity of the output result with higher accuracy based on the process of output can be achieved.

Especially, according to the eleventh invention, the weights are calculated for the plurality of respective local servers based on the cumulative gradient values. This allows updating the global model by the local server using the calculated weights without communication, and therefore, the learning can be performed with a small volume of communication. According to the eleventh invention, since the gradient values can be cumulated in an encrypted state, the confidentiality can be enhanced.

Especially, according to the twelfth invention, the global models are updated for the plurality of respective local servers. This allows updating the global model by the local server without transmitting and receiving the global model, and therefore, the learning can be performed with a small volume of communication.

Especially, according to the thirteenth invention, the generated current local model is encrypted. This allows learning with high confidentiality.

Especially, according to the fourteenth invention, the local server for generating the current local model is selected from the plurality of local servers. This allows generating the local model using the local training data stored in the various local servers, and therefore, the learning can be performed with more variety.

Especially, according to the fifteenth invention, the calculation unit calculates the random value as the gradient value based on the dummy model. Accordingly, since the gradient value includes a dummy value, the learning can be performed with higher confidentiality.

### BRIEF DESCRIPTION OF THE DRAWINGS

FIG. 1 is a block diagram illustrating a configuration of a federated learning system to which a first embodiment is applied.

FIG. 2 is a sequence diagram for describing a federated learning function to which the first embodiment is applied.

FIG. 3 is a flowchart illustrating a processing procedure of a local server process.

FIG. 4 is a flowchart illustrating a processing procedure of a central server process.

FIG. 5 is a block diagram illustrating a configuration of a federated learning system to which a second embodiment is applied.

FIG. 6 is a schematic diagram of the federated learning system to which the second embodiment is applied.

FIG. 7 is a flowchart illustrating an operation of the federated learning system to which the second embodiment is applied.

FIG. 8 is a schematic diagram of a federated learning system to which a third embodiment is applied.

FIG. 9 is a flowchart illustrating an operation of the federated learning system to which the third embodiment is applied.

FIG. 10 is a schematic diagram of a federated learning system to which a fourth embodiment is applied.

FIG. 11 is a flowchart illustrating an operation of the federated learning system to which the fourth embodiment is applied.

FIG. 12 is a schematic diagram of a federated learning system to which a fifth embodiment is applied.

FIG. 13 is a flowchart illustrating an operation of the federated learning system to which the fifth embodiment is applied.

FIG. 14 is a schematic diagram of a federated learning system to which a sixth embodiment is applied.

FIG. 15 is a flowchart illustrating an operation of the federated learning system to which the sixth embodiment is applied.

### DESCRIPTION OF PREFERRED EMBODIMENTS

### First Embodiment

The following describes a federated learning system to which a first embodiment of the present invention is applied with reference to the drawings.

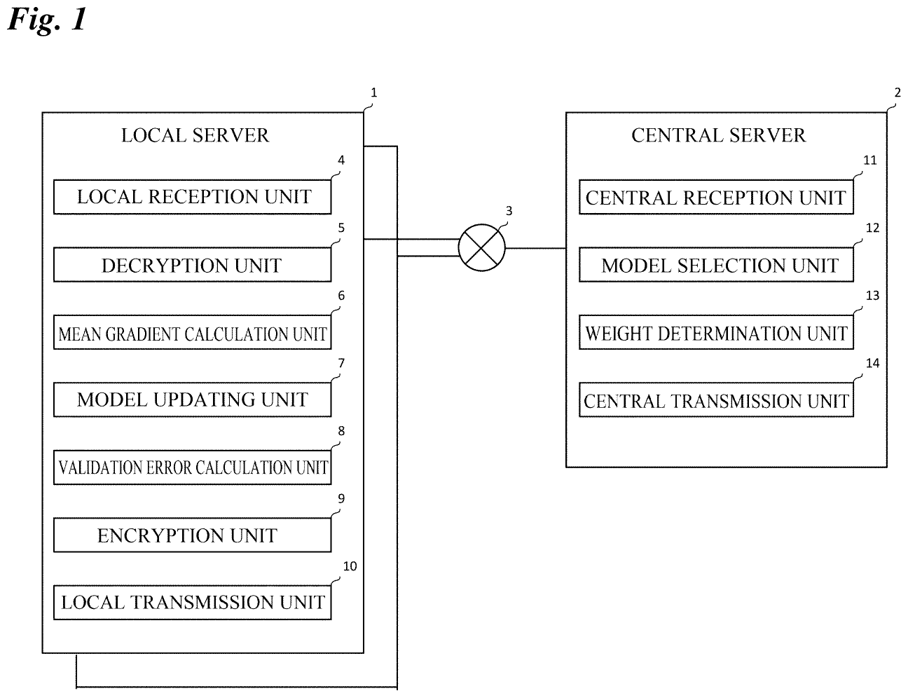

FIG. 1 is a block diagram illustrating a configuration of the federated learning system to which the first embodiment is applied. As illustrated in FIG. 1, in the federated learning system to which the first embodiment is applied, a plurality of, for example, D, local servers 1 communicate with a central server 2 via a network 3, such as the Internet, and through the communication, the plurality of local servers 1 repeatedly learns a global model cooperatively. The global model is a decision tree or a decision tree group including a shape of a tree indicating a relation between data and a branch condition indicating a weight of the relation.

An example of i-th (hereinafter, it may be referred to as current) learning among, for example, Z times of learning will be described. In this embodiment, for example, the learning is continuous learning that is machine learning in which Z is a very large number.

The local server 1 includes a local reception unit 4, a decryption unit 5, a mean gradient calculation unit 6, a model updating unit 7, a validation error calculation unit 8, an encryption unit 9, and a local transmission unit 10. The local reception unit 4, the decryption unit 5, the mean gradient calculation unit 6, the model updating unit 7, the validation error calculation unit 8, the encryption unit 9, and the local transmission unit 10 are mutually connected via an internal bus (not illustrated), and are, for example, programs that are called by a CPU (Central Processing Unit) and recorded in a RAM (Random Access Memory).

The central server 2 includes a central reception unit 11, a model selection unit 12, a weight determination unit 13, and a central transmission unit 14. The central reception unit 11, the model selection unit 12, the weight determination unit 13, and the central transmission unit 14 are mutually connected via an internal bus (not illustrated), and are, for example, programs that are called by the CPU and recorded in the RAM.

The local reception unit 4 receives an encrypted previous global model enc(Tᵢ₋₁^{K_(i-1)}) generated by i−1-th (hereinafter, it may be referred to as previous) learning and a previous weight wᵢ₋₁^{K_(i-1)} indicating a weight of a previous global model enc(Tᵢ₋₁^{K_(i-1)}) from the central server 2. The decryption unit 5 decrypts the encrypted previous global model enc(Tᵢ₋₁^{K_(i-1)}), and generates a previous global model Tᵢ₋₁^{K_(i-1)}. Here, K_i is a number of the local server 1 used for the i-th learning, and when the number of the local servers 1 is D, K_i is any number of 1 to D. kⁱ is the number of the local servers 1 used for the i-th learning, and for example, when D is 10 and K_i is 1, 4, and 5, kⁱ is 3. K_(i−1) is a number of the local server 1 used for the i−1-th learning. Encrypted information may be referred to as ciphertext, and may be expressed as enc( . . . ).

The mean gradient calculation unit 6 calculates a current local mean gradient G̅ᵢ̅^̅{̅j̅}̅ from the previous global model Tᵢ₋₁^{K_(i-1)}, past global models T₁^{K_1} to Tᵢ₋₂^{K_(i-2)} before the previous time described below, and current local data including current local training data Rᵢ^{Nij} and a current local training data count Nᵢ^{j} used for current learning. The current local mean gradient G̅ᵢ̅^̅{̅j̅}̅ is the mean of a gradient calculated from the previous global model Tᵢ₋₁^{K_(i-1)}. The gradient indicates a sensitivity to an error between a predicted value and a measured value of an output result of the model. A local mean gradient G̅ᵢ̅^̅{̅j̅}̅˜G̅ᵢ̅^̅{̅j̅}̅ may be simply referred to as a mean gradient. Here, j is any one of 1 to D, and indicates which of the plurality of local servers 1 is the local server.

The model updating unit 7 generates a current local model Tᵢ^{j} from the previous global model Tᵢ₋₁^{K_(i-1)} and the past global models (hereinafter, they may be referred to as 1st to i−2-th global models) T₁^{K_1}, . . . , Tᵢ₋₂^{K_(i-2)}. The model updating unit 7 determines the model so as to decrease the error to a minimum using the gradient. In this case, the model updating unit 7 may generate the current local model Tᵢ^{j} using, for example, an algorithm of GBDT (Gradient Boosting Decision Trees).

The validation error calculation unit 8 calculates a current local validation error 80 that is the mean of a prediction error from a current global model Tᵢ^{K_i} and the current local data.

The encryption unit 9 generates an encrypted current local model enc(Tᵢ^{j}) obtained by encrypting the current local model Tᵢ^{j}.

The local transmission unit 10 transmits the encrypted current local model enc(Tᵢ^{j}) and at least one of the current local training data count Nᵢ^{j}, the current local mean gradient G̅ᵢ̅^̅{̅j̅}̅ and the current local validation error δᵢ^{j} to the central server 2.

The central reception unit 11 receives the encrypted current local models enc(Tᵢ¹), . . . , enc(Tᵢ^{j}), . . . , enc(Tᵢ^{D}) and at least one of the current local training data counts Nᵢ¹, . . . , Nᵢ^{j}, . . . , Nᵢ^{D}, the current local mean gradients G̅ᵢ̅¹̅, . . . , G̅ᵢ̅^̅{̅j̅}̅, . . . , G̅ᵢ̅^̅{̅D̅}̅ and the current local validation errors δᵢ¹, . . . , δᵢ^{j}, . . . , δᵢ^{D} from the plurality of respective local servers 1.

The model selection unit 12 selects at least one of the encrypted current local models enc(Tᵢ¹), . . . , enc(Tᵢ^{j}), . . . , enc(Tᵢ^{D}) received from the plurality of respective local servers 1 by a predetermined method, and sets the selected one as an encrypted current global model enc(Tᵢ^{K_i}).

The weight determination unit 13 determines a current weight wᵢ^{K_i} of the encrypted current global model enc(Tᵢ^{K_i}) by a predetermined method.

The central transmission unit 14 transmits the encrypted current global model enc(Tᵢ^{K_i}) and the current weight wᵢ^{K_i} to each of the plurality of local servers 1.

The global models T₁^{K_1}, . . . , Tᵢ^{K_i}, . . . , T_{Z}^{K_Z} and the local models T₁^{j}, . . . , Tᵢ^{j}, . . . , T_{Z}^{j} are each a model as a decision tree or a decision tree group including a shape of a tree indicating a relation between data and a branch condition indicating a weight of the relation. The global models T₁^{K_1}, . . . , Tᵢ^{K_i}, . . . , T_{Z}^{K_Z} are respectively provided with weights w₁^{K_1}, . . . , wᵢ^{K_i}, . . . , w_{Z}^{K_Z} that are weights of relations between data. The relation between data is indicated by a branch condition held by what is called a node. A terminal node of the decision tree may be referred to as a leaf.

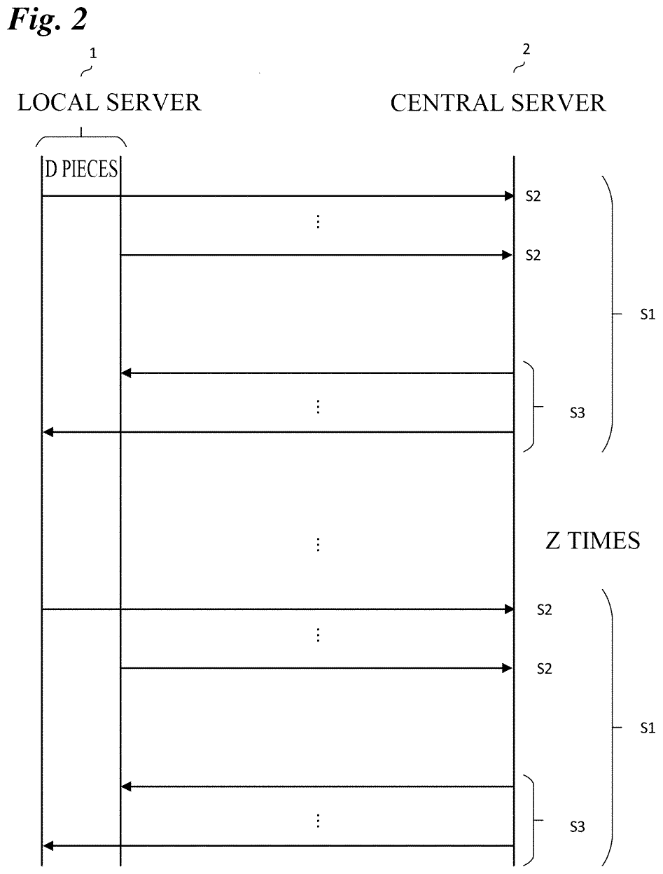

With reference to FIG. 2, the flow of data between the plurality of local servers 1 and the central server 2 in the federated learning system will be described. FIG. 2 is a sequence diagram for describing a federated learning function according to this embodiment.

As illustrated in FIG. 2, the federated learning system according to this embodiment repeats federated learning by a federated learning process S1, for example, Z times. The federated learning process S1 includes a local server process S2 performed by the plurality of local servers 1 and a central server process S3 performed by the central server 2.

The plurality of local servers 1 have a common key in common, and perform decryption and encryption by the common key. While the central server 2 does not have the common key and does not decrypt the encrypted information, it is not limited to this, and may have the common key in common as necessary and perform decryption and encryption by the common key.

The plurality of D local servers 1 each perform the local server process S2, and transmit the current local training data count Nᵢ^{j}, the encrypted current local model enc(Tᵢ^{j}), the current local mean gradient G̅ᵢ̅^̅{̅j̅}̅ and the current local validation error δᵢ^{j} to the central server 2.

When the central server 2 receives the current local training data count Nᵢ^{j}, the encrypted current local model enc(Tᵢ^{j}), the current local mean gradient G̅ᵢ̅^̅{̅j̅}̅ and the current local validation error δᵢ^{j} by the preliminarily registered number, for example, D, the central server 2 performs the central server process S3.

The central server 2 transmits the encrypted current global model enc(Tᵢ^{K_i}) and the current weight wᵢ^{K_i} to each of the plurality of, for example, D, local servers 1 as the central server process S3.

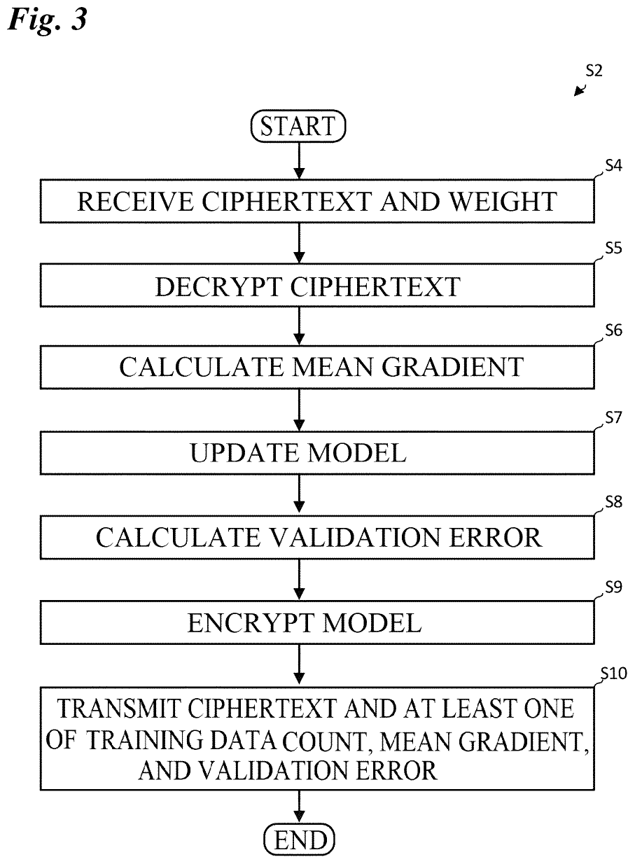

With reference to FIG. 3, the local server process S2 will be described in detail. FIG. 3 is a flowchart illustrating a processing procedure of the local server process S2. First, the local reception unit 4 receives the encrypted previous global model enc(Tᵢ₋₁^{K_(i-1)}) and the previous weight wᵢ^{K_(i-1)} from the central server 2 in Step S4.

Next, in Step S5, the decryption unit 5 decrypts the encrypted previous global model enc(Tᵢ₋₁^{K_(i-1)}), and generates the previous global model Tᵢ₋₁^{K_(i-1)}.

Next, in Step S6, the mean gradient calculation unit 6 calculates the current local mean gradient G̅ᵢ̅^̅{̅j̅}̅ from the previous global model Tᵢ₋₁^{K_(i-1)}, the past global models T₁^{K_1} to Tᵢ₋₂^{K_(i-2)} before the previous time, and the current local data stored in the local server.

The current local data is calculated using a part of or all of up-to-the-previous-time local training data R₁^{N1j} to Rᵢ₋₁^{N(i-1)j} and up-to-the-previous-time local training data counts N₁^{j} to Nᵢ₋₁^{j} as local data up to the previous time. The local server 1 in which the current local data is not changed from the previous local data does not need to transmit the current local mean gradient G̅ᵢ̅^̅{̅j̅}̅ to the central server in learning at that time.

The current local data includes the current local training data Rᵢ^{Nij} and the current local training data count Nᵢ^{j} used for the current learning. The current local training data Rᵢ^{Nij} includes current main data R_{i_main}^{Nij} used for the learning and current validation data R_{i_vali}^{Nij} for obtaining the prediction error of the model. The current local training data Rᵢ^{Nij} is divided into X_i pieces, one piece of the divided current local training data Rᵢ^{Nij} is used as the current validation data R_{i_vali}^{Nij}, and the other X_i−1 pieces of the data are used as the current main data R_{i_main}^{Nij}. The prediction error is an error between the predicted value and the measured value obtained using the current validation R_{i_vali}^{Nij} after learning with the current main data R_{i_main}^{Nij}.

The current local data is stored in a storage unit (not illustrated), such as a solid state drive, included in the local server 1.

Next, in Step S7, the model updating unit 7 generates the current local model Tᵢ^{j} from the previous global model Tᵢ₋₁^{K_(i-1)}, the past global models T₁^{K_1}, . . . , Tᵢ₋₂^{K_(i-2)}, and the current local data, thereby updating the model.

Next, in Step S8, the validation error calculation unit 8 calculates the current local validation error 60 from the current global model Tᵢ^{K_i} and the current local data including the current local training data Rᵢ^{Nij} and the current local training data count N stored in the local server.

The current local validation error δᵢ^{j} is a mean of X_i prediction errors each obtained when each piece of the current local training data Rᵢ^{Nij} divided into X_i pieces is used as the validation data R_{i_vali}^{Nij}.

Next, in Step S9, the encryption unit 9 encrypts the current local model Tᵢ^{j}, and generates the encrypted current local model enc(Tᵢ^{j}), thereby encrypting the model.

Next, in Step S10, the local transmission unit 10 transmits the encrypted current local model enc(Tᵢ^{j}) and at least one of the current local training data count Nᵢ^{j}, the current local mean gradient G̅ᵢ̅^̅{̅j̅}̅ and the current local validation error δᵢ^{j} to the central server 2. The local server process S2 is completed by the above-described Steps S4 to S10.

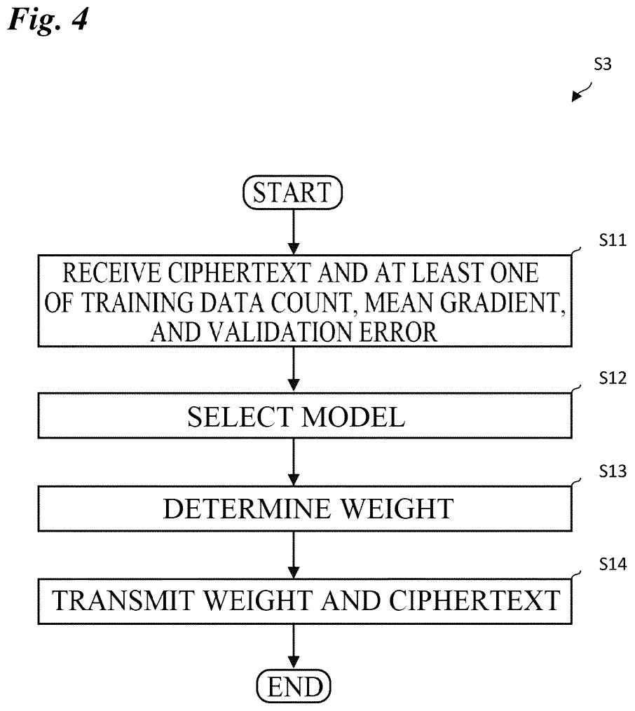

With reference to FIG. 4, the central server process S3 will be described in detail. FIG. 4 is a flowchart illustrating a processing procedure of the central server process S3. First, in Step S11, the central reception unit 11 receives the encrypted current local models enc(Tᵢ¹), . . . , enc(Tᵢ^{j}), . . . , enc(Tᵢ^{D}) and at least one of the current local training data counts Nᵢ¹, . . . , Nᵢ^{j}, . . . , Nᵢ^{D}, the current local mean gradients G̅ᵢ̅¹̅, . . . , G̅ᵢ̅^̅{̅j̅}̅, . . . , G̅ᵢ̅^̅{̅D̅}̅ and the current local validation errors δᵢ¹, . . . , δᵢ^{j}, . . . , δᵢ^{D} from the plurality of respective local servers 1.

Next, in Step S12, the model selection unit 12 selects at least one of the encrypted current local models enc(Tᵢ¹), . . . , enc(Tᵢ^{j}), . . . , enc(Tᵢ^{D}) received from the plurality of respective local servers 1 by a predetermined method, and sets the selected one as the encrypted current global model enc(Tᵢ^{k_i}).

As the predetermined method, for example, the model selection unit 12 may randomly select at least one of the encrypted current local models enc(Tᵢ¹), . . . , enc(Tᵢ^{j}), . . . , enc(Tᵢ^{D}) received from the plurality of local servers 1 as the encrypted current global model enc(Tᵢ^{K_i}).

In the random selection method, since the calculation amount in the selection can be reduced compared with a case of using the current local mean gradients G̅ᵢ̅²̅, . . . , G̅ᵢ̅^̅{̅j̅}̅, . . . , G̅ᵢ̅^̅{̅D̅}̅ the current local validation errors δᵢ¹, . . . , δᵢ^{j}, . . . , δᵢ^{D}, or the like, speed-up can be expected.

The random selection method eliminates the need for transmitting the current local mean gradients G̅ᵢ̅²̅, . . . , G̅ᵢ̅^̅{̅j̅}̅, . . . , G̅ᵢ̅^̅{̅D̅}̅ or the current local validation errors δᵢ¹, . . . , δᵢ^{j}, . . . , δᵢ^{D} from the local servers 1 to the central server 2. Therefore, since the possibility of the leakage of the local data of the local server 1 and the like is reduced, and the volume of communication is decreased, the processing speed is increased.

The model selection unit 12 may align the encrypted current local models enc(Tᵢ¹), . . . , enc(Tᵢ^{j}), . . . , enc(Tᵢ^{D}) received from the plurality of local servers 1 by a predetermined method using at least one of the current local training data counts Nᵢ¹, . . . , Nᵢ^{j}, . . . , Nᵢ^{D}, the current local mean gradients G̅ᵢ̅²̅, . . . , G̅ᵢ̅^̅{̅j̅}̅, . . . , G̅ᵢ̅^̅{̅D̅}̅ and the current local validation errors δᵢ¹, . . . , δᵢ^{j}, . . . , δᵢ^{D} received from the plurality of respective local servers, and may select at least one as the encrypted current global model enc(Tᵢ^{K_i}) by a predetermined method.

For example, the predetermined method for the aligning means using the current local mean gradients G̅ᵢ̅¹̅, . . . , G̅ᵢ̅^̅{̅j̅}̅, . . . , G̅ᵢ̅^̅{̅D̅}̅ to align the corresponding encrypted current local models enc(Tᵢ¹), . . . , enc(Tᵢ^{j}), . . . , enc(Tᵢ^{D}).

The predetermined method for the selection means selecting kⁱ pieces from the encrypted current local models enc(Tᵢ¹), . . . , enc(Tᵢ^{j}), . . . , enc(Tᵢ^{D}) in descending order of the current local mean gradients G̅ᵢ̅¹̅, . . . , G̅ᵢ̅^̅{̅j̅}̅, . . . , G̅ᵢ̅^̅{̅D̅}̅.

For example, the predetermined method for the aligning means using the current local validation errors δᵢ¹, . . . , δᵢ^{j}, . . . , δᵢ^{D} to align the encrypted current local models enc(Tᵢ¹), . . . , enc(Tᵢ^{j}), . . . , enc(Tᵢ^{D}).

The predetermined method for the selection means selecting kⁱ pieces from the encrypted current local models enc(Tᵢ¹), . . . , enc(Tᵢ^{j}), . . . , enc(Tᵢ^{D}) in ascending order of the current local validation errors δᵢ¹, . . . , δᵢ^{j}, . . . , δᵢ^{D}.

For example, the predetermined method for the aligning means using the current local training data counts Nᵢ¹, . . . , Nᵢ^{j}, . . . , Nᵢ^{D} to align the encrypted current local models enc(Tᵢ¹), . . . , enc(Tᵢ^{j}), . . . , enc(Tᵢ^{D}).

The predetermined method for the selection means selecting kⁱ pieces from the encrypted current local models enc(Tᵢ¹), . . . , enc(Tᵢ^{j}), . . . , enc(Tᵢ^{D}) in descending order of the current local training data counts Nᵢ¹, . . . , Nᵢ^{j}, . . . , Nᵢ^{D}.

Next, in Step S13, the weight determination unit 13 determines the current weight wᵢ^{K_i} of the encrypted current global model enc(Tᵢ^{K_i}) by a predetermined method.

As the predetermined method, for example, the weight determination unit 13 may determine the current weights wᵢ^{K_i} of the encrypted current global models enc(Tᵢ^{K_i}), setting to be the same and to be 1/kⁱ.

For example, when the weight determination unit 13 sets the current weights wᵢ^{K_i} to be the same, the model selection unit 12 can randomly select the encrypted current local models enc(Tᵢ¹), . . . , enc(Tᵢ^{j}), . . . , enc(Tᵢ^{D}).

The weight determination unit 13 may determine the current weight wᵢ^{K_i} of the encrypted current global model enc(Tᵢ^{K_i}) using at least one of the current local training data counts Nᵢ¹, . . . , Nᵢ^{j}, . . . , Nᵢ^{D}, the current local mean gradients G̅ᵢ̅¹̅, . . . , G̅ᵢ̅^̅{̅j̅}̅, . . . , G̅ᵢ̅^̅{̅D̅}̅ and the current local validation errors δᵢ¹, . . . , δᵢ^{j}, . . . , δᵢ^{D} received from the plurality of respective local servers 1. For example, the weight determination unit 13 may determine the current weight wᵢ^{K_i} of the encrypted current global model enc(Tᵢ^{K_i}) with ratios as indicated by the current local mean gradients G̅ᵢ̅¹̅, . . . , G̅ᵢ̅^̅{̅j̅}̅, . . . , G̅ᵢ̅^̅{̅D̅}̅.

For example, the weight determination unit 13 may determine the current weight wᵢ^{K_i} of the encrypted current global model enc(Tᵢ^{K_i}) with inverses of the current local validation errors δᵢ¹, . . . , δᵢ^{j}, . . . , δᵢ^{D} as ratios.

For example, the weight determination unit 13 may determine the current weight wᵢ^{K_i} of the encrypted current global model enc(Tᵢ^{K_i}) with ratios as indicated by the current local training data counts Nᵢ¹, . . . , Nᵢ^{j}, . . . , Nᵢ^{D}.

Next, in Step S14, the central transmission unit 14 transmits the encrypted current global models enc(Tᵢ^{K_i}) and the current weights wᵢ^{K_i} to the plurality of respective local servers 1. The central server process S3 is completed by the above-described Steps S11 to S14.

As described above, according to the federated learning system of this embodiment, an explanatory variable importance as a degree of importance of an explanatory variable calculated in the computation in the central server 2 can be obtained, and a selection index such as a mean gradient is not encrypted. Therefore, the validity of the output result is easily explained based on the process of output.

Additionally, according to the federated learning system of this embodiment, in concealing information, instead of using s-differential privacy that requires adding a noise, for example, a cryptographic technology, such as AES (Advanced Encryption Standard), which is an algorithm of a symmetric key cipher, is used. Therefore, a reduction in accuracy caused by adding the noise is avoided.

The central server 2 does not aggregate or process gradient information of the respective local servers 1 and does not generate statistical information, but the central server 2 uses the mean gradient. Therefore, the respective local servers 1 and the central server 2 do not need to have their respective gradient information in common more than necessary. Since the central server 2 uses the mean gradient, each of the local servers 1 can maintain the confidentiality to the other local servers 1 and the central server 2.

When a depth of a decision tree is d, while the communication between the central server 2 and the local server 1 requires to be performed 2^{d}−1 times in a case where the central server 2 performs aggregation and a process for each node of the decision tree, performing the process for each decision tree in the local server 1 requires only one-time communication, thus allowing speed-up of the process.

While the encryption in the local server 1 requires to be performed 2^{d}−1 times in the case where the central server 2 performs aggregation and a process for each node of the decision tree, performing the process for each decision tree in the local server 1 requires only one-time encryption in the local server 1, thus allowing speed-up of the process.

According to the federated learning system of this embodiment, in the encryption, the central server 2 does not perform a homomorphic calculation such as an addition in an encrypted state of ciphertext. This allows the use of a symmetric cipher using a common key with a shorter processing time than homomorphic encryption in which the homomorphic calculation can be performed, thus improving the processing speed.

Specifically, the federated learning system according to this embodiment is applicable to, for example, an illegal money transfer detection system in a bank. For example, assume that the plurality of local servers 1 are respective servers in a plurality of branches of a bank, and the central server 2 is a server in the central branch of the bank.

The federated learning process according to this embodiment is effective also in a case where, for example, it is difficult to perform the process during ordinary bank business hours because hardware resources are required for the process, and the process is performed on weekends or the like when the bank is not open.

For example, a description will be given of an exemplary case where a communication failure occurs in one branch on a weekend, and communication to the local server 1 is impossible. In the existing technique, in the case where the central server 2 aggregates and processes gradient information of the respective local servers 1, the federated learning process needs to be performed on a weekend with the central server 2 and the plurality of local servers 1. Therefore, the federated learning process needs to be performed on the next weekend.

In contrast, in the federated learning system according to this embodiment, the local servers 1 perform the respective processes using information in the respective local servers 1, and the process in the central server 2 does not require so many hardware resources.

Therefore, the local server 1 in which the communication failure does not occur performs the process on the weekend similarly to the ordinary case, and transmits the information to the central server 2. The central server 2 does not perform the process yet. The local server 1 in which the communication failure has occurred completes the process on the weekend, and performs the communication with the central server 2 when the communication failure is resolved. The central server 2 only needs to perform the process without waiting for the weekend after receiving the information from the local server 1 in which the communication failure has occurred.

For example, when the process in the central server 2 is performed at the point when the information has been gathered from all the registered local servers 1, the need for a process such as branching necessary in implementation in the existing technique is eliminated. Also in an operation, the need for an operation due to the implementation is eliminated.

This embodiment is not limited to synchronous learning in which the central server 2 performs the central server process S3 when the central server 2 receives the current local training data count Nᵢ^{j}, the encrypted current local model enc(Tᵢ^{j}), the current local mean gradient G̅ᵢ̅^̅{̅j̅}̅ and the current local validation error δᵢ^{j} by the preliminarily registered number, for example, D.

This embodiment may be asynchronous learning in which the number of the local servers 1 is less than D, and the central server 2 performs the central server process S3, for example, even based on the information from one local server 1.

In this embodiment, one of the local servers 1 may serve as the central server 2. For example, when the local server 1 with a large amount of the local data serves as the central server 2, since the need for the communication between the local server 1 with a large amount of the local data and the central server 2 is eliminated, the communication frequency can be reduced, and the processing speed can be improved. For example, the local server 1 with a large amount of the local data is provided in a megabank with a large number of customer accounts.

In the case where one of the local servers 1 serves as the central server 2, the central server 2 has a common key that can decrypt a part of the encrypted information. In the case where one of the local servers 1 serves as the central server 2, or other cases, the central server 2 may use the current local model Tᵢ^{j} instead of the encrypted current local model enc(Tᵢ^{j}) for the model of the local server 1 that serves as the central server 2.

While a case where the local reception unit 4, the decryption unit 5, the mean gradient calculation unit 6, the model updating unit 7, the validation error calculation unit 8, the encryption unit 9, the local transmission unit 10, the central reception unit 11, the model selection unit 12, the weight determination unit 13, and the central transmission unit 14 are programs has been described in the above-described embodiment, this embodiment is not limited thereto.

For example, the local reception unit 4, the decryption unit 5, the mean gradient calculation unit 6, the model updating unit 7, the validation error calculation unit 8, the encryption unit 9, the local transmission unit 10, the central reception unit 11, the model selection unit 12, the weight determination unit 13, and the central transmission unit 14 may be implemented by an integrated circuit.

### Second Embodiment

The following describes a federated learning system to which a second embodiment of the present invention is applied. The description similar to the first embodiment will be omitted.

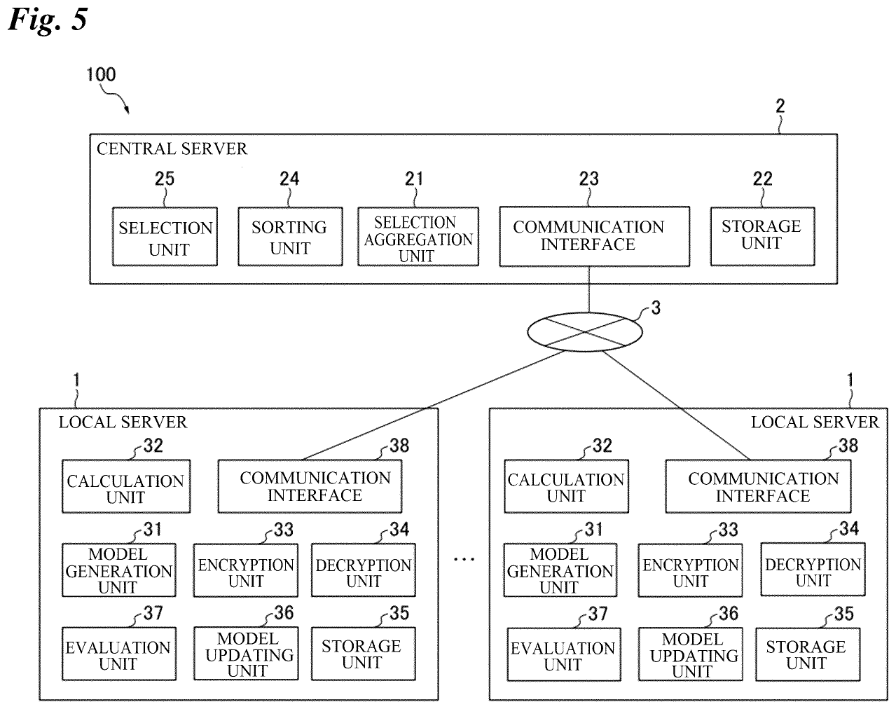

FIG. 5 is a block diagram illustrating a configuration of a federated learning system 100 to which the second embodiment is adapted. In the federated learning system 100, a plurality of local servers 1 mutually communicate, and repeatedly learns cooperatively.

The local server 1 includes a model generation unit 31, a calculation unit 32, a model updating unit 36, an encryption unit 33, a decryption unit 34, a storage unit 35, an evaluation unit 37, and a communication interface 38, which are each connected to an internal bus (not illustrated).

A central server 2 includes a selection aggregation unit 21, a storage unit 22, a sorting unit 24, and a selection unit 25, which are each connected to an internal bus (not illustrated).

The model generation unit 31 generates a current local model based on a global model generated by past learning and current local training data used for current learning.

The calculation unit 32 calculates various kinds of values, such as a gradient value as a value of a gradient, based on the current local model, the global model generated by the past learning, and the current local training data stored in the storage unit 35.

The evaluation unit 37 evaluates a degree of accuracy, the AUC (Area Under the Curve), an accuracy, a precision, a recall, or the like of the current local model.

The model updating unit 36 updates the global model based on the current local model. For example, the model updating unit 36 updates the global model based on the current local model and the current local training data.

The encryption unit 33 encrypts various kinds of information. The decryption unit 34 decrypts the various kinds of encrypted information. The encryption unit 33 may use any cipher such as additive homomorphic encryption, fully homomorphic encryption, somewhat homomorphic encryption, and secret sharing.

The storage unit 35 stores various kinds of information, for example, local training data and the global model.

The communication interface 38 is an interface for communication between the plurality of local servers 1 and the central server 2 via a network 3.

The selection aggregation unit 21 calculates a cumulative gradient value obtained by cumulating the gradient values transmitted from the plurality of local servers 1.

The storage unit 22 is a storage medium such as a memory for storing various kinds of information.

A communication interface 23 is an interface for communication with the plurality of local servers 1 via the network 3.

The sorting unit 24 sorts local models transmitted from the plurality of local servers 1.

The selection unit 25 selects a builder server that is the local server 1 for generating the current local model from the plurality of local servers 1.

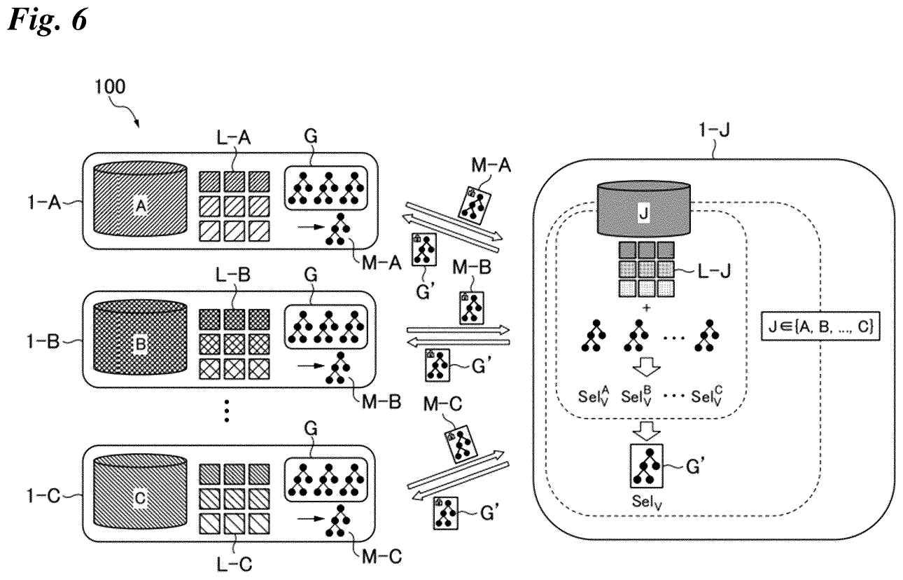

FIG. 6 is a schematic diagram of the federated learning system 100 to which the second embodiment of the present invention is applied. In the federated learning system 100, the plurality of local servers 1 communicate with an aggregator 1-J selected from the plurality of local servers 1 via the network 3, thereby repeatedly learning the global model cooperatively. It is not necessary to use all of the local servers 1 for each learning, and any two or more local servers 1 may be used.

The aggregator 1-J is a local server 1 selected from the plurality of local servers 1 for updating the current global model. The aggregator 1-J may be selected from the local servers 1 using any method.

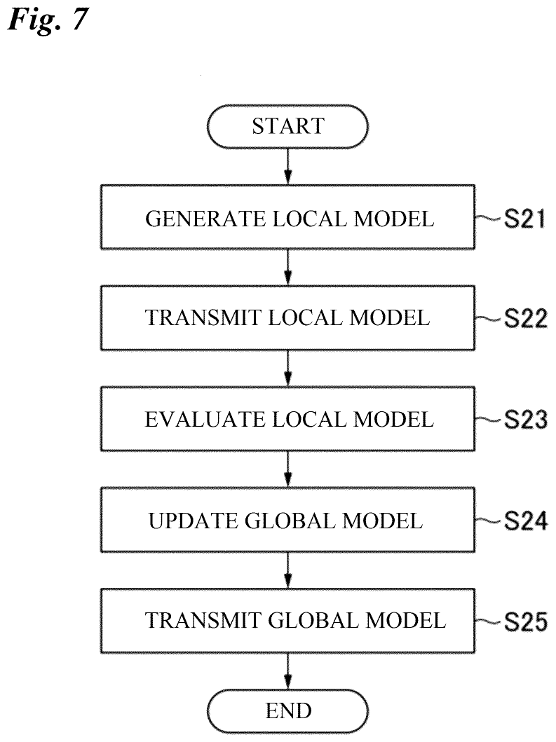

The following describes an operation of the federated learning system 100 to which the second embodiment is applied with reference to FIG. 6 and FIG. 7.

FIG. 7 is a flowchart illustrating the operation of the federated learning system 100 to which the second embodiment is applied. First, in Step S21, the plurality of local servers 1 generate current local models M based on a global model G generated by the past learning and current local training data L.

In Step S21, for example, local servers 1-A, 1-B, . . . , 1-C generate current local models M-A, M-B, . . . , M-C respectively based on the past global model G and current local training data L-A, L-B, . . . , L-C stored in the local servers 1-A, 1-B, . . . , 1-C respectively. All of the local servers 1 do not necessarily generate the respective current local models M, and any two or more local servers 1 may generate the respective current local models M. The current local model M is a decision tree or a decision tree group including a shape of a tree indicating a relation between the local training data and a weight of the relation.

Next, in Step S22, the plurality of local servers 1 transmit the respective current local models M generated in Step S21 to the aggregator 1-J. For example, the local servers 1-A, 1-B, . . . , 1-C transmit the generated current local models M-A, M-B, . . . , M-C respectively to the aggregator 1-J. In this case, the current local models M-A, M-B, . . . , M-C encrypted by the encryption unit 33 may be transmitted.

Next, in Step S23, the aggregator 1-J evaluates each of the current local models M transmitted in Step S22. For example, in Step S22, the aggregator 1-J evaluates degrees of accuracy of the current local models M-A, M-B, . . . , M-C transmitted from the local server 1-A, 1-B, . . . , 1-C respectively using current local training data L-J stored in the aggregator 1-J. For example, the aggregator 1-J may obtain the AUC of the current local model M-A using an ROC (Receiver Operating Characteristic) curve on a graph having a vertical axis indicating a true positive rate and a horizontal axis indicating a false positive rate when it is determined that an estimated probability equal to or more than a threshold is positive. The aggregator 1-J may calculate errors between predicted values and measured values and gradients of the current local models M-A, M-B, . . . , M-C using the current local training data L-J, and may evaluate the current local models M-A, M-B, . . . , M-C based on the calculated errors and gradients.

Next, in Step S24, the aggregator 1-J selects at least one of the current local models M based on evaluation results evaluated in Step S23, and sets the selected current local model M as a current global model G′. For example, the current local model M having the highest evaluation result in the accuracy evaluated in Step S23 may be selected as the current global model G′.

Next, in Step S25, the current global model G′ selected in Step S24 is transmitted to the plurality of local servers 1. The local server 1 reflects the transmitted current global model G′ in the global model G, and updates the global model G. This allows reflecting the current global model G′ in which the contents of the local training data L stored in the two local servers 1 have been reflected in the global model G, in the global model G. Accordingly, the learning of the global model G can be performed with higher accuracy. The federated learning system 100 ends the i-th learning operation by the above-described steps.

### Third Embodiment

The following describes a federated learning system 100 to which a third embodiment of the present invention is applied. The description similar to the first embodiment and the second embodiment will be omitted. The third embodiment is different from the second embodiment in that a central server sorts encrypted current local models transmitted from a plurality of local servers.

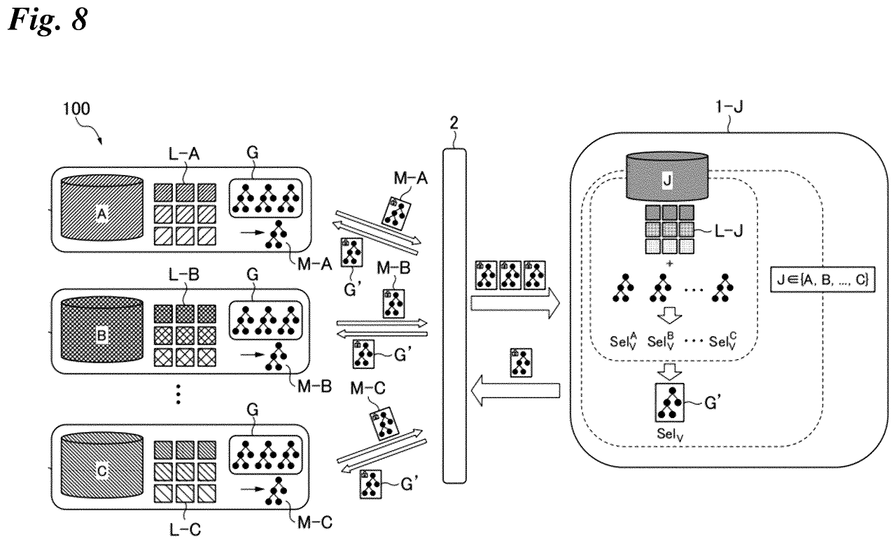

FIG. 8 is a schematic diagram of the federated learning system 100 to which the third embodiment of the present invention is applied. In the federated learning system 100, a plurality of local servers 1, an aggregator 1-J, and a central server 2 mutually communicate, thereby repeatedly learning cooperatively. The central server 2 may be a local server 1 selected from the plurality of local servers 1.

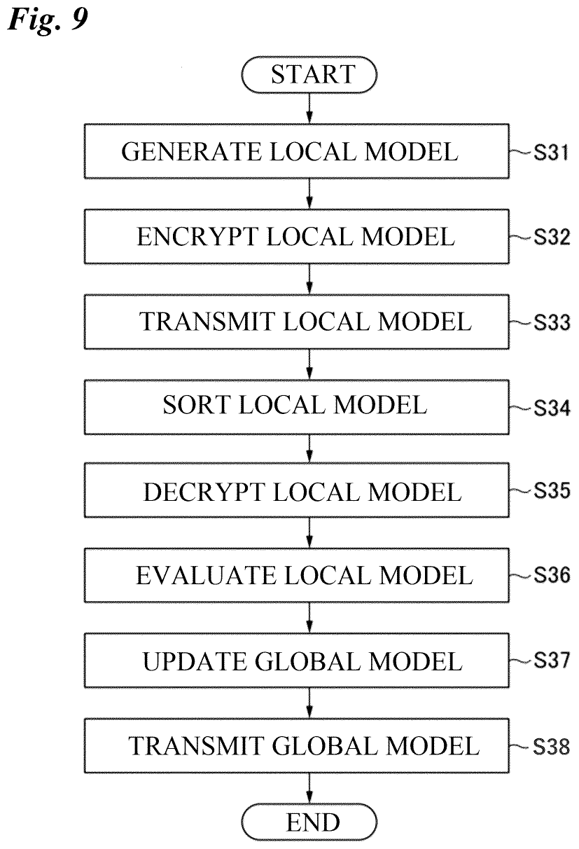

The following describes an operation of the federated learning system 100 to which the third embodiment is applied with reference to FIG. 8 and FIG. 9. FIG. 9 is a flowchart illustrating the operation of the federated learning system 100 to which the third embodiment is applied. In the federated learning system 100, in Step S31, the plurality of local servers 1 generate current local models M based on a global model G generated by past learning and current local training data L.

Next, in Step S32, the plurality of local servers 1 encrypt the generated current local models M. For example, local servers 1-A, 1-B, . . . , 1-C encrypt generated current local models M-A, M-B, . . . , M-C, respectively. This allows maintaining the confidentiality even when the current local models M are transmitted to the central server 2.

Next, in Step S33, the plurality of local servers 1 transmit the respective current local models M encrypted in Step S32 to the central server 2. For example, the local servers 1-A, 1-B, . . . , 1-C transmit the encrypted current local models M-A, M-B, . . . , M-C respectively to the central server 2.

Next, in Step S34, the central server 2 sorts the plurality of current local models M transmitted in Step S33. In this case, for example, while the central server 2 may randomly sort the plurality of current local models M, it is not limited to this, and the sorting may be performed by any method. This makes it impossible to identify which local server 1 generates which current local model M from the transmission order of the current local models M from the plurality of local servers 1, and therefore, the confidentiality can be enhanced.

In Step S34, the central server 2 transmits the plurality of sorted current local models M to the aggregator l-J.

Next, in Step S35, the aggregator 1-J decrypts the plurality of local models M transmitted in Step S34.

Next, in Step S36, the aggregator 1-J evaluates each of the decrypted current local models M.

Next, in Step S37, at least one of the current local models M is selected based on evaluation results evaluated in Step S36, and the selected current local model M is set as a current global model G′. The aggregator 1-J transmits the selected current local model M to the central server 2 as the current global model G′. In this case, the aggregator 1-J transmits the encrypted current global model G′ to the central server 2.

Next, in Step S38, the current global model G′ transmitted to the central server 2 in Step S37 is transmitted to the plurality of local servers 1.

The federated learning system 100 ends the i-th learning operation by the above-described steps. The central server 2 may communicate with the plurality of local servers 1 using a channel with high confidentiality, such as TLS (Transport Layer Security). This allows learning without communication between the local servers storing the local training data L. Accordingly, the learning can be performed with higher confidentiality.

### Fourth Embodiment

The following describes a federated learning system 100 to which a fourth embodiment of the present invention is applied. The description similar to the first embodiment to the third embodiment will be omitted.

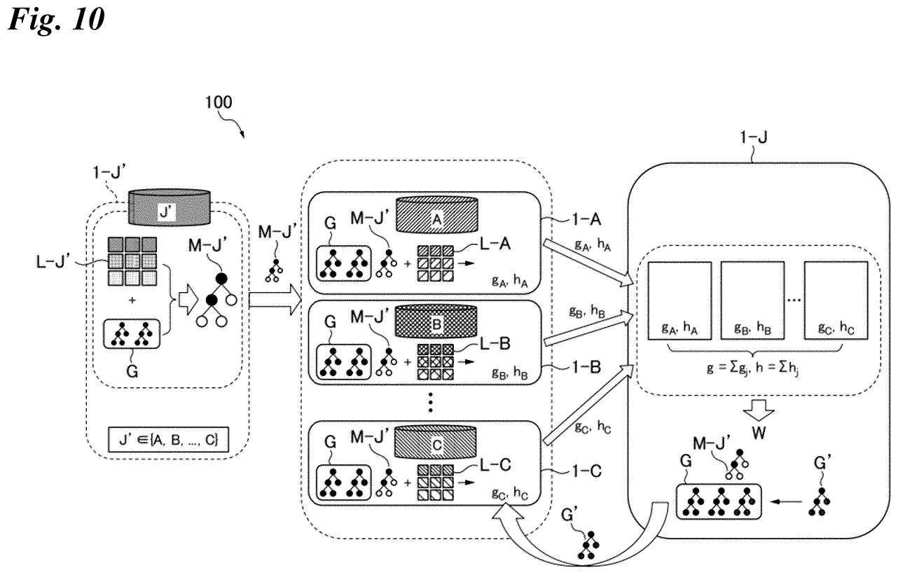

FIG. 10 is a schematic diagram of the federated learning system 100 to which the fourth embodiment of the present invention is applied. In the federated learning system 100, a plurality of local servers 1, an aggregator 1-J selected from the plurality of local servers 1, and a builder server 1-J′ selected from the plurality of local servers 1 for generating a current local model M mutually communicate, thereby repeatedly learning cooperatively. The federated learning system 100 may use a central server 2 as an aggregator.

The builder server 1-J′ is a local server 1 selected from the plurality of local servers 1 for generating the current local model M. The builder server 1-J′ may be selected from the local servers 1 using any method.

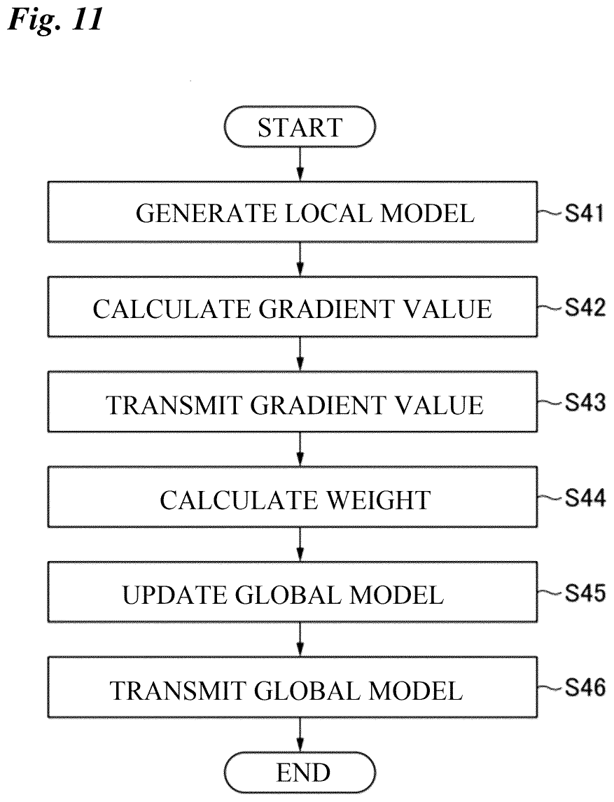

The following describes an operation of the federated learning system 100 to which the fourth embodiment is applied with reference to FIG. 10 and FIG. 11. The federated learning system 100 uses the plurality of local servers 1 to calculate respective gradient values and weights based on the local model M generated via one or more local servers 1, and updates a global model.

FIG. 11 is a flowchart illustrating the operation of the federated learning system 100 to which the fourth embodiment is applied. In the federated learning system 100, in Step S41, the builder server 1-J′ generates a current local model M-J′ based on a past global model G and current local training data L-J′ stored in the builder server 1-Y. In this case, the current local model M-J may be a decision tree or a decision tree group including a shape of a tree indicating a relation between the current local training data L-J′ without a weight of the relation between the current local training data L-J′. The current local model M-J may be a model in which a leaf node is empty. The current local model M-J may be a decision tree or a decision tree group including a shape of a tree indicating a relation between the local training data and a weight of the relation. The builder server 1-J′ transmits the generated current local model M-J′ to the plurality of local servers 1.

Next, in Step S42, the plurality of local servers 1 each calculate gradient values gᵢ, hⱼ based on the current local model M-J′ transmitted in Step S41, the global model G generated by past learning, and current local training data L stored in each of the plurality of local servers 1.

In this case, first, the plurality of local servers 1 calculate a loss function l(yᵢ, ŷᵢ^{(t-1)}) indicating an error between a predicted value and a measured value of a result as output of the current local model M-J. The loss function l(yᵢ, ŷᵢ^{(t-1)}) is calculated using, for example, a formula (1) indicated by Math. 1 below.

[Math. 1]

l(yᵢ,ŷᵢ^{(t-1)})=yᵢ ln(1+e^{-ŷ}^{ᵢ})+(1−yᵢ)ln(1+e^{ŷ}^{ᵢ}) (1)

Here, ŷᵢ^{(t-1)} indicates a predicted value based on a relation between t−1 pieces of data in the i-th learning, and y; indicates a measured value. The gradient value gⱼ is obtained by partially differentiating the loss function l(yᵢ, ŷᵢ^{(t-1)}) and indicated by, for example, a formula (2) of Math. 2 below.

$$\begin{matrix}[ Math . 2 ] & \\ {g}_{i} = \frac{1}{1 + {e}^{- {\hat{y}}_{i}^{( t - 1 )}}} - {y}_{i} , {h}_{i} = \frac{1}{1 + {e}^{- {\hat{y}}_{i}^{( t - 1 )}}} * ( 1 - \frac{1}{1 + {e}^{- {\hat{y}}_{i}^{( t - 1 )}}} ) . & ( 2 )\end{matrix}$$

The gradient value hⱼ obtained by partially differentiating the loss function l(yᵢ, ŷᵢ^{(t-1)}) twice may be calculated.

Next, in Step S43, the plurality of local servers 1 transmit the respective gradient values gⱼ, hⱼ calculated in Step S42 to the aggregator 1-J.

Next, in Step S44, the aggregator 1-J calculates a weight W of the relation between the current local training data L-J′ based on the gradient values gⱼ, hⱼ each transmitted in Step S43. In this case, for example, the loss function l(yᵢ, ŷᵢ^{(t-1)}) as the error between the predicted value and the measured value of the result as the output of the current local model M-J′ varies corresponding to a parameter such as the weight W. Therefore, since the loss function l(yᵢ, ŷᵢ^{(t-1)}) becomes minimum when the gradient value gⱼ as the gradient of the loss function l(yᵢ, ŷᵢ^{(t-1)}) becomes 0, by searching the weight W at which the gradient value gⱼ becomes 0, the weight W can be calculated. In Step S44, for example, the aggregator 1-J may calculate cumulative gradient values g, h obtained by cumulating the respective gradient values gⱼ, hⱼ, and may calculate the weight W based on the cumulative gradient values g, h. The cumulative gradient values g, h are indicated by, for example, a formula (3) of Math. 3.

$$\begin{matrix}[ Math . 3 ] & \\ g = {\sum }_{j}^{D} {g}_{j} h = {{\sum }_{j}}^{D} {h}_{j} & ( 3 )\end{matrix}$$

Next, in Step S45, the aggregator 1-J updates the global model G based on the current local models M-J′ and the weight W.

Next, in Step S46, the aggregator 1-J transmits the updated global model G to each of the plurality of local servers 1.

The federated learning system 100 ends the i-th learning operation by the above-described steps. This allows reflecting a current global model G′ in which the contents of the local training data L stored in the two or more local servers 1 have been reflected in the global model G, in the global model G. Accordingly, the federated learning system 100 capable of explaining the validity of an output result with higher accuracy based on the process of the output can be achieved.

### Fifth Embodiment

The following describes a federated learning system 100 to which a fifth embodiment of the present invention is applied. The description similar to the first embodiment to the fourth embodiment will be omitted.

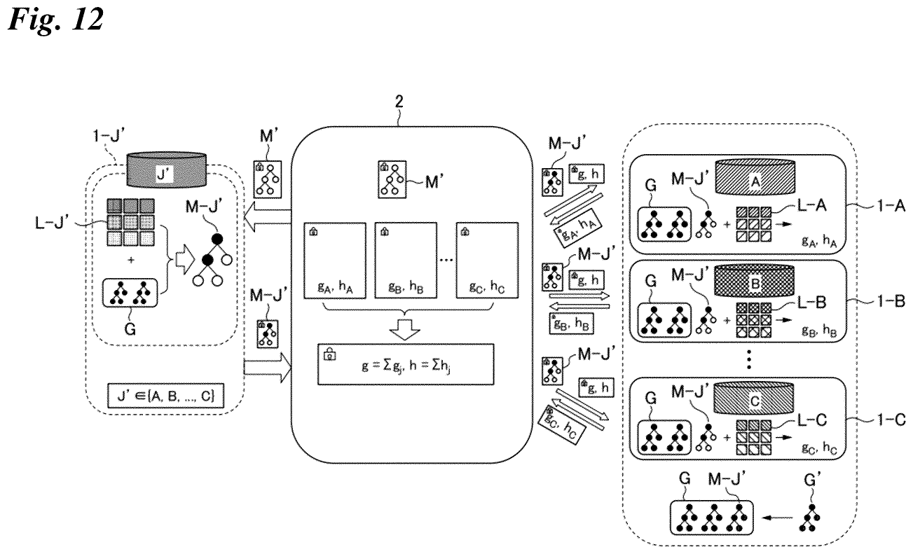

FIG. 12 is a schematic diagram of the federated learning system 100 to which the fifth embodiment of the present invention is applied. In the federated learning system 100, a plurality of local servers 1, a builder server 1-J′, and a central server 2 mutually communicate, thereby repeatedly learning cooperatively. The federated learning system 100 may use the local server 1 as the central server 2.

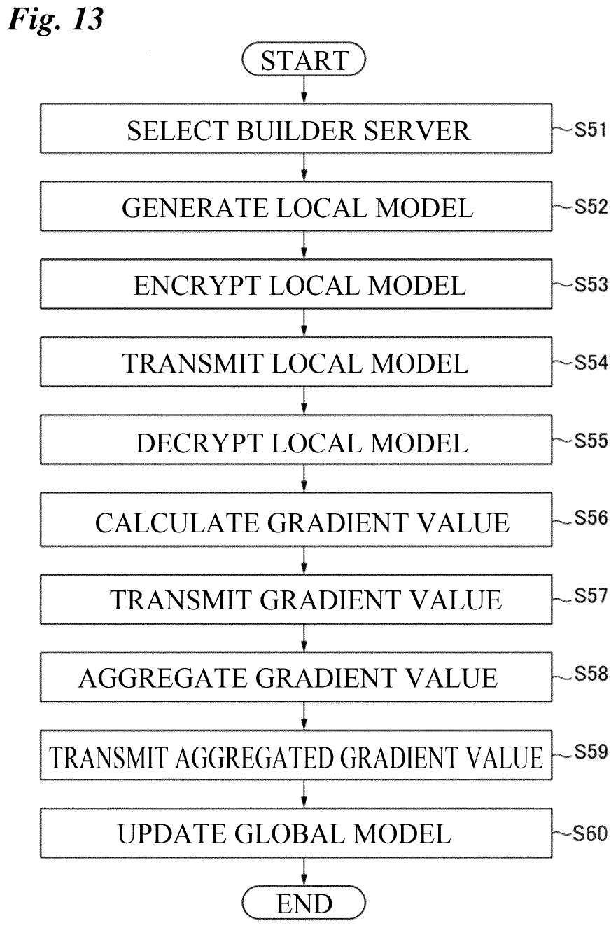

The following describes an operation of the federated learning system 100 to which the fifth embodiment is applied with reference to FIG. 12 and FIG. 13.

FIG. 13 is a flowchart illustrating the operation of the federated learning system 100 to which the fifth embodiment is applied. First, in Step S51, the central server 2 selects the builder server 1-J′ from the plurality of local servers 1. In this case, for example, while the central server 2 may randomly select the builder server 1-J′, it is not limited to this, and the selection may be performed by any method.

Next, in Step S52, the builder server 1-J′ selected in Step S51 generates a current local model M-J′ based on a past global model G and current local training data L-J′ stored in the builder server 1-J′. The current local model M-J′ may be a decision tree or a decision tree group including a shape of a tree indicating a relation between the current local training data L-J′ without a weight W of the relation between the current local training data L-J′. The current local model M-J′ may be a model in which a leaf node is empty.

Next, in Step S53, the builder server 1-J′ encrypts the current local model M-J′ generated in Step S52.

Next, in Step S54, the builder server 1-J′ transmits the current local model M-J′ encrypted in Step S53 to the central server 2. The central server 2 to which the encrypted current local model M-J′ has been transmitted transmits the encrypted current local model M-J′ to the plurality of local servers 1.

Next, in Step S55, the plurality of local servers 1 decrypt the encrypted current local model M-J′ received in Step S54.

Next, in Step S56, the plurality of local servers 1 each calculate gradient values gⱼ, hⱼ based on the current local model M-J′ decrypted in Step S55, the global model G generated by past learning, and the current local training data L stored in each of the plurality of local servers 1.

Next, in Step S57, the plurality of local servers 1 encrypt the respective gradient values gⱼ, hⱼ calculated in Step S56, and transmit the encrypted gradient values gⱼ, hⱼ to the central server 2. For example, the plurality of local servers 1 may provide encrypted gradient values obtained by encrypting the respective gradient values gⱼ, hⱼ using additive homomorphic encryption.

Next, in Step S58, the central server 2 cumulates the encrypted gradient values gⱼ, hⱼ transmitted in Step S57, and calculates encrypted cumulative gradient values g, h.

Next, in Step S59, the central server 2 transmits the encrypted cumulative gradient values g, h calculated in Step S58 to the plurality of local servers 1.

Next, in Step S60, the plurality of local servers 1 decrypt the encrypted cumulative gradient values g, h transmitted in Step S59, and calculate a weight W of the current local model M-J′ based on the decrypted cumulative gradient values g, h. The plurality of local servers 1 update the global model G based on the calculated weight W.

The federated learning system 100 ends the i-th learning operation by the above-described steps. The central server 2 may communicate with the plurality of local servers 1 using a channel with high confidentiality, such as TLS (Transport Layer Security). This allows learning without communication between the local servers storing the local training data L. Accordingly, the learning can be performed with higher confidentiality.

### Sixth Embodiment

The following describes a federated learning system 100 to which a sixth embodiment of the present invention is applied. The description similar to the first embodiment will be omitted.

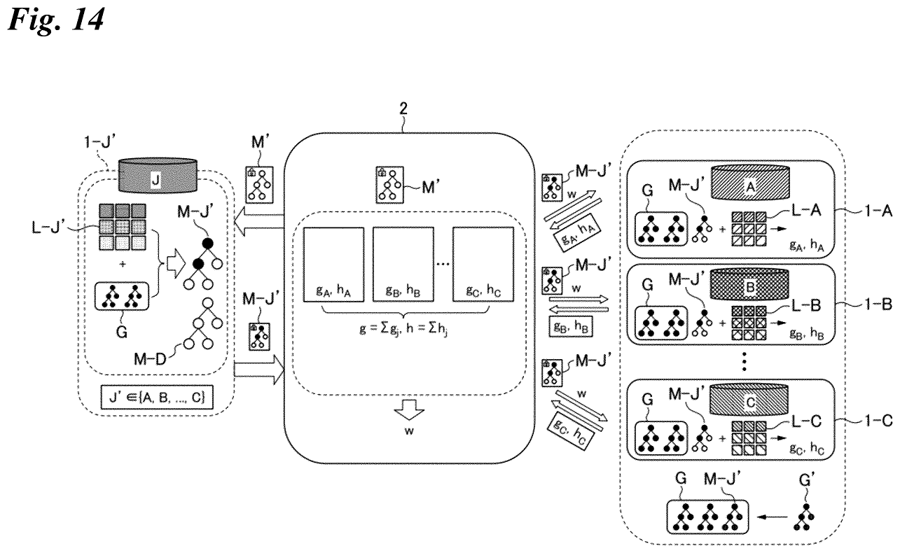

FIG. 14 is a schematic diagram of the federated learning system 100 to which the sixth embodiment of the present invention is applied. In the federated learning system 100, a plurality of local servers 1, a builder server 1-J′, and a central server 2 mutually communicate, thereby repeatedly learning cooperatively. The federated learning system 100 may use the local server 1 as the central server 2.

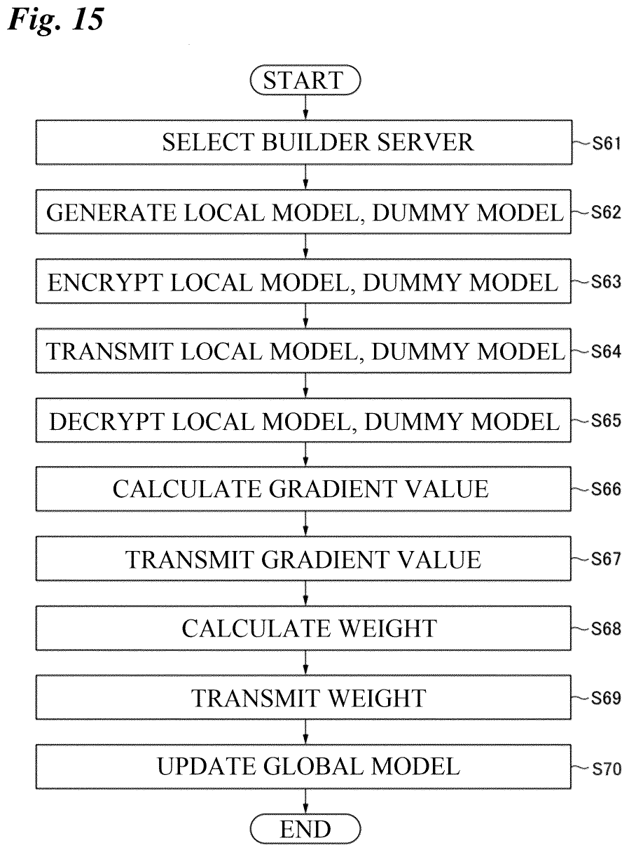

The following describes an operation of the federated learning system 100 to which the sixth embodiment is applied with reference to FIG. 14 and FIG. 15.

FIG. 15 is a flowchart illustrating the operation of the federated learning system 100 to which the sixth embodiment is applied. First, in Step S61, the central server 2 selects the builder server 1-J′ from the plurality of local servers 1.

Next, in Step S62, the builder server 1-J′ selected in Step S61 generates a current local model M-J′ or a dummy model M-D for calculating random values as gradient values gⱼ, hⱼ. While the dummy model M-D may be a model, for example, without a relation between current local training data L-J′ and a weight W of the relation, it is not limited to this, and any model may be used.

Next, in Step S63, the builder server 1-J′ encrypts the current local model M-J′ or the dummy model M-D generated in Step S62.

Next, in Step S64, the builder server 1-J′ transmits the current local model M-J′ or the dummy model M-D encrypted in Step S63 to the central server 2. The central server 2 to which the encrypted current local model M-J′ or dummy model M-D has been transmitted transmits the encrypted current local model M-J′ or dummy model M-D to the plurality of local servers 1.

Next, in Step S65, the plurality of local servers 1 decrypt the encrypted current local model M-J′ or dummy model M-D transmitted in Step S64.

Next, in Step S66, the plurality of local servers 1 each calculate gradient values gⱼ, hⱼ based on the current local model M-J′ decrypted in Step S65, a global model G generated by past learning, and the current local training data L-J′ stored in each of the plurality of local servers. When the dummy model M-D is transmitted in Step S64, the plurality of local servers 1 calculate random values as the gradient values gⱼ, hⱼ based on the dummy model M-D in Step S66. In this case, while the gradient values gⱼ, hⱼ are not limited to the random values, the plurality of local servers 1 may set values calculated by any method as the gradient values gⱼ, hⱼ. Accordingly, since the gradient values gⱼ, hⱼ include dummy values, the confidentiality is enhanced.

Next, in Step S67, the plurality of local servers 1 transmit the respective gradient values gⱼ, hⱼ calculated in Step S66 to the central server 2.

Next, in Step S68, the central server 2 cumulates the gradient values gⱼ, hⱼ transmitted in Step S67, calculates a cumulative gradient values g, h, and calculates the weight W based on the cumulative gradient values g, h.

Next, in Step S69, the central server 2 transmits the weight W calculated in Step S68 to each of the plurality of local servers 1.

Next, in Step S70, the plurality of local servers 1 calculate the weight W of the current local model M-J′ based on the cumulative gradient values g, h transmitted in Step S69. The plurality of local servers 1 update the global model G based on the calculated weight W.

The federated learning system 100 ends the i-th learning operation by the above-described steps. In the federated learning system 100, a specific data owner determines a structure of a decision tree including weights of respective nodes and their positional relation, and weights of leaves as the other components are cooperatively calculated by all data owners. Therefore, the weights of the leaves having a large influence on prediction performance while having a small number of times of communication necessary for the calculation and a small amount of information to be disclosed are calculated by an entire organization, and the structure of the tree having a small influence on the prediction performance while having a large number of times of communication necessary for the calculation and a large amount of information to be disclosed is determined by one local server 1. This allows the suppression of all of the number of times of communication necessary for the update, the amount of information to be disclosed to another organization, and the reduction in prediction performance.

### DESCRIPTION OF REFERENCE SIGNS

1: Local server
2: Central server
3: Network
4: Local reception unit
5: Decryption unit
6: Mean gradient calculation unit
7: Model updating unit
8: Validation error calculation unit
9: Encryption unit
10: Local transmission unit
11: Central reception unit
12: Model selection unit
13: Weight determination unit
14: Central transmission unit
21: Selection aggregation unit
22: Storage unit
23: Communication interface
24: Sorting unit
25: Selection unit
31: Model generation unit
32: Calculation unit
33: Encryption unit
34: Decryption unit
35: Storage unit
36: Model updating unit
37: Evaluation unit
38: Communication interface
100: Federated learning system

1. A federated learning system in which a plurality of local servers repeatedly learn cooperatively through communication between the plurality of local servers and a central server via a network, wherein
the local server includes:
a local reception unit that receives an encrypted previous global model and a previous weight from the central server;
a decryption unit that decrypts the received encrypted previous global model, and generates a previous global model;
a mean gradient calculation unit that calculates a current local mean gradient from the previous global model, past global models before the previous time, and current local data including current local training data and a current local training data count stored in the local server;
a model updating unit that generates a current local model from the previous global model, the past global models, and the current local data;
a validation error calculation unit that calculates a current local validation error from the current local model and the current local data;
an encryption unit that encrypts the current local model, and generates an encrypted current local model; and
a local transmission unit that transmits the encrypted current local model and at least one of the current local training data count, the current local mean gradient, and the current local validation error,
the global model and the local model are each a model as a decision tree or a decision tree group including a shape of a tree and a branch condition, and
the central server includes:
a central reception unit that receives the encrypted current local models and at least one of the current local training data counts, the current local mean gradients, and the current local validation errors from the plurality of respective local servers;
a model selection unit that selects at least one of the encrypted current local models received from the plurality of respective local servers by a predetermined method, and sets the selected encrypted current local model as an encrypted current global model;
a weight determination unit that determines a current weight of the encrypted current global model by a predetermined method; and
a central transmission unit that transmits the encrypted current global model and the current weight to each of the plurality of local servers.

2. The federated learning system according to claim 1, wherein
the current local data is calculated using a part of or all of local data up to the previous time, and the learning is continuous learning.

3. The federated learning system according to claim 1, wherein
the model selection unit aligns the encrypted current local models received from the plurality of local servers by a predetermined method using at least one of the current local training data counts, the current local mean gradients, and the current local validation errors received from the plurality of respective local servers, and the model selection unit selects at least one as the encrypted current global model by a predetermined method.

4. The federated learning system according to claim 1, wherein
the weight determination unit sets the current weights of the selected encrypted current global models to be the same.

5. The federated learning system according to claim 1, wherein
the weight determination unit determines the current weight of the encrypted current global model using at least one of the current local training data counts, the current local mean gradients, and the current local validation errors received from the plurality of respective local servers.

6. A federated learning method by a federated learning system in which a plurality of local servers repeatedly learn cooperatively through communication between the plurality of local servers and a central server via a network, the federated learning method comprising:
in the local server,
a first step of receiving an encrypted previous global model and a previous weight from the central server;
a second step of decrypting the received encrypted previous global model, and generating a previous global model;
a third step of calculating a current local mean gradient from the previous global model, past global models before the previous time, and current local data including current local training data and a current local training data count stored in the local server;
a fourth step of generating a current local model from the previous global model, the past global models, and the current local data;
a fifth step of calculating a current local validation error from the current local model and the current local data;
a sixth step of encrypting the current local model, and generating an encrypted current local model; and
a seventh step of transmitting the encrypted current local model and at least one of the current local training data count, the current local mean gradient, and
the current local validation error, wherein
the global model and the local model are each a model as a decision tree or a decision tree group including a shape of a tree and a branch condition, and
the federated learning method comprises:
in the central server,
an eighth step of receiving the encrypted current local models and at least one of the current local training data counts, the current local mean gradients, and the current local validation errors from the plurality of respective local servers;
a ninth step of selecting at least one of the encrypted current local models received from the plurality of respective local servers by a predetermined method, and setting the selected encrypted current local model as an encrypted current global model;
a tenth step of determining a current weight of the encrypted current global model by a predetermined method; and
an eleventh step of transmitting the encrypted current global model and the current weight to each of the plurality of local servers.

7. A federated learning system in which a global model is communicated between a plurality of local servers and repeatedly learned cooperatively, the global model being a decision tree or a decision tree group including a shape of a tree indicating a relation between local training data and a weight of the relation, the federated learning system comprising:
a model generation unit that generates current local models for the respective two or more local servers based on a global model generated by past learning and current local training data used for current learning;
an evaluation unit that evaluates the current local models generated for the respective two or more local servers by the model generation unit via at least one of the local servers; and
a model updating unit that selects at least one of the current local models generated for the respective two or more local servers by the model generation unit based on the evaluation by the evaluation unit, and updates the global model based on the selected current local model.

8. The federated learning system according to claim 7, comprising:
a transmission unit that transmits the current local models generated by the model generation unit for the respective two or more local servers;
a sorting unit that sorts the two or more current local models transmitted for the respective two or more local servers by the transmission unit; and
a central transmission unit that transmits the two or more current local models sorted by the sorting unit to at least one of the local servers.

9. The federated learning system according to claim 7, wherein
the transmission unit encrypts the current local models generated for the respective two or more local servers by the model generation unit, and transmits the encrypted current local models.

10. A federated learning system in which a global model is communicated between a plurality of local servers and repeatedly learned cooperatively, the global model being a decision tree or a decision tree group including a shape of a tree indicating a relation between local training data and a weight of the relation, the federated learning system comprising:
a model generation unit that generates a current local model via at least one of the local servers based on a global model generated by past learning and current local training data used for current learning;
a gradient calculation unit that calculates gradient values for the respective two or more local servers based on the current local model generated by the model generation unit, the global model, and the current local training data, the gradient value being based on a function indicating an error between a predicted value and a measured value of an output result of the current local model;
a calculation unit that calculates the weight based on the gradient values calculated for the respective two or more local servers by the gradient calculation unit; and
a global model updating unit that updates the global model based on the current local model generated by the model generation unit and the weight calculated by the calculation unit.

11. The federated learning system according to claim 10, wherein
the gradient calculation unit encrypts the gradient values calculated for the respective two or more local servers, calculates cumulative gradient values by cumulating the respective encrypted gradient values, and transmits the calculated cumulative gradient values to the respective two or more local servers, and
the calculation unit calculates the weights for the respective two or more local servers based on the cumulative gradient values transmitted by the gradient calculation unit.

12. The federated learning system according to claim 10, wherein
the calculation unit transmits the calculated weights to the respective two or more local servers, and
the global model updating unit updates the global models for the respective two or more local servers.

13. The federated learning system according to claim 10, wherein
the model generation unit encrypts the generated current local model.

14. The federated learning system according to claim 10, further comprising
a selection unit that selects a local server for generating the current local model from the two or more local servers, wherein
the model generation unit generates the current local model by the local server selected by the selection unit.

15. The federated learning system according to claim 10, wherein
the model generation unit generates a dummy model for calculating a random value as the current local model or the gradient value, and
the gradient calculation unit calculates the random value as the gradient value based on the dummy model generated by the model generation unit.

16. A federated learning method in which a global model is communicated between a plurality of local servers and repeatedly learned cooperatively, the global model being a decision tree or a decision tree group including a shape of a tree indicating a relation between local training data and a weight of the relation, the federated learning method comprising:
a model generation step of generating current local models for the respective two or more local servers based on a global model generated by past learning and current local training data used for current learning;
an evaluation step of evaluating the current local models generated for the respective two or more local servers by the model generation step via at least one of the local servers; and
a model updating step of selecting at least one of the current local models generated for the respective two or more local servers by the model generation step based on the evaluation by the evaluation step, and updates the global model based on the selected current local model.

17. A federated learning method in which a global model is communicated between a plurality of local servers and repeatedly learned cooperatively, the global model being a decision tree or a decision tree group including a shape of a tree indicating a relation between local training data and a weight of the relation, the federated learning method comprising:
a model generation step of generating a current local model via at least one of the local servers based on a global model generated by past learning and current local training data used for current learning;
a gradient calculation step of calculating gradient values for the respective two or more local servers based on the current local model generated by the model generation step, the global model, and the current local training data, the gradient value being based on a function indicating an error between a predicted value and a measured value of an output result of the current local model;
a calculation step of calculating the weight based on the gradient values calculated for the respective two or more local servers by the gradient calculation step; and
a global model updating step of updating the global model based on the current local model generated by the model generation step and the weight calculated by the calculation step.
